(19) United States
(12) Patent Application Publication
(10) Pub. No.: US 2014/0242562 A1
(43) Pub. Date: Aug. 28, 2014

(54) ELECTRONIC HAND WASHING REMINDER

(71) Applicant: SKANA Global, LLC, Bowie, MD (US)

(72) Inventors: Kertia MCSTERLING, Bowie, MD (US); Nekisha Roache, Bowie, MD (US); Shonita Bond, Bowie, MD (US); Annette Gill, LaPlata, MD (US); Anushka Clare, Ellicott City, MD (US)

(73) Assignee: SKANA Global, LLC, Bowie, MD (US)

(21) Appl. No.: 14/192,181

(22) Filed: Feb. 27, 2014

Related U.S. Application Data
(60) Provisional application No. 61/770,012, filed on Feb. 27, 2013.

(51) Int. Cl. G08B 21/24

(52) U.S. Cl. CPC G08B 21/245
USPC 434/257; 340/573.1

(57) ABSTRACT

A motion detection device that offers an audio/video reminder to wash the hands is disclosed. The device is desirable for use in public restrooms or other environments where frequent hand washing is required. The device provides a product that can effectively increase hygienic hand washing while educating patrons of proper hand washing techniques and optionally the health benefits and/or health code requirements of doing so.

### CROSS-REFERENCE TO RELATED APPLICATIONS

This application claims priority to U.S. Provisional No. 61/770,012 filed Feb. 27, 2013 and entitled “Hand Washing Reminder,” the content of which is incorporated by reference in its entirety.

### FIELD

This invention relates generally to an electronic hand washing reminder and, more particularly, the invention relates to an audio/video device for emitting an audio and/or video message to remind patrons to wash their hands and/or provide instructions on proper hand washing techniques prior to leaving a restroom.

### BACKGROUND

Perhaps the most important time to wash the hands is after utilizing a public restroom. Used by many people during the course of a day, these public facilities are often hotbeds of unsanitary conditions. Unfortunately, in today's fast-paced and hectic world, many people forget to wash their hands even after using these restrooms. Whether in a hurry to continue traveling or to get back to work, people sometimes simply walk out of the restroom without stopping for five seconds to cleanse the germs and bacteria that have likely attached themselves to the palms and fingers. While it is bad enough that regular consumers may neglect a hand washing, it can be even worse when food service personnel or hospital staff is remiss in practicing good hygiene. Directly handling people's meals and tending to the sick, these workers could conceivably spread a massive amount of germs to the populace at large.

Accordingly, it is desirable to provide a hand washing reminder in the form of an electronic device that can be located within a public restroom. The electronic device would provide an audio and/or video message to the restroom's patron to remind the individual to wash his or her hands, and/or instruct the individual on proper hand washing techniques, prior to the individual leaving the restroom.

### SUMMARY

The present disclosure provides a motion detection device that offers an audio/video reminder to wash the hands. The device is desirable for use in public restrooms or other environments where frequent hand washing is required. The device provides a product that can effectively increase hygienic hand washing while educating patrons of proper hand washing techniques and optionally the health benefits and/or health code requirements of doing so.

In one embodiment, an electronic device for transmitting a message to wash hands is provided. The device may include a case comprising a front panel and back panel that houses an internal speaker and microphone for emitting and recording an audio message regarding hand washing. The device may further include a motion detection sensor, wherein the activation of the motion detection sensor initiates the emission of the audio message.

The device may include a video display on the front panel, the device being configured to transmit a video message regarding hand washing. According to one aspect of the disclosure, the video message comprises a series of diagrams illustrating proper hand washing techniques. According to another aspect of the disclosure, the video message comprises a video clip showing proper hand washing techniques.

The device may also include a communications port for attachment to another electronic device for downloading data. In addition, the device may further include a smoke detector and/or a carbon monoxide detector. The device may also be configured to release an odor-absorbing or odor-masking substance.

The electronic device may be wall mountable, and utilized in public restrooms, cafeterias, laboratories, or other environments where routine or frequent hand washing is desirable. The device is customizable to the environment or to the target audience.

In another embodiment, an electronic system for transmitting a message to wash hands is provided. The system may include at least one audio device comprising a case having a front panel and back panel, the case housing internal speakers and a microphone for emitting and recording an audio message regarding hand washing, and further including a motion detection sensor, wherein the activation of the motion detection sensor initiates the emission of the audio message. The system may further include at least one video device in electronic communication with the at least one audio device, the at least one video device comprising a case having a front panel and back panel including a video display on the front panel and being configured to transmit a video message regarding hand washing.

According to one aspect of the disclosure, the video message comprises a series of diagrams illustrating proper hand washing techniques. According to another aspect of the disclosure, the video message comprises a video clip showing proper hand washing techniques. The video message may be displayed simultaneously with the audio message. Alternatively, the video message may be displayed at a different time than the audio message.

Each of the devices may also include a communications port for attachment to another electronic device for downloading data. In addition, the system may further include a smoke detector and/or a carbon monoxide detector. The system may also be configured to release an odor-absorbing or odor-masking substance.

The system may be wall mountable, and utilized in public restrooms, cafeterias, laboratories, or other environments where routine or frequent hand washing is desirable. The system is customizable to the environment or to the target audience.

It is to be understood that both the foregoing general description and the following detailed description are exemplary and explanatory only and are not restrictive of the disclosure. Additional features of the disclosure will be set forth in part in the description which follows or may be learned by practice of the disclosure.

### BRIEF DESCRIPTION OF THE DRAWINGS

The accompanying drawings, which are incorporated in and constitute a part of this specification, illustrate several embodiments of the disclosure and together with the description, serve to explain the principles of the disclosure.

FIG. 1 is a perspective front view of an exemplary embodiment of an electronic hand washing reminder in accordance with the present disclosure.

FIG. 2 is a rear view of the electronic hand washing reminder of FIG. 1 in accordance with the present disclosure.

FIG. 3 is a side view of the electronic hand washing reminder of FIG. 1 in accordance with the present disclosure.

FIG. 4 is a front view of another exemplary embodiment of an electronic hand washing reminder in accordance with the present disclosure

### DESCRIPTION OF THE EMBODIMENTS

The present disclosure provides an electronic message board to remind patrons of public restrooms to wash their hands before leaving the restroom. The message board may emit an audio message reminding patrons of the restroom to wash their hands prior to leaving the restroom. The message board may also display a video message that reminds the patrons to wash their hands, or provide instructions on proper hand washing techniques. The message board may provide either an audio or video message, or both, in combination. In addition, the message board may be configured with motion sensors to activate upon movement, and remain in a dormant or sleep mode when no movement is detected.

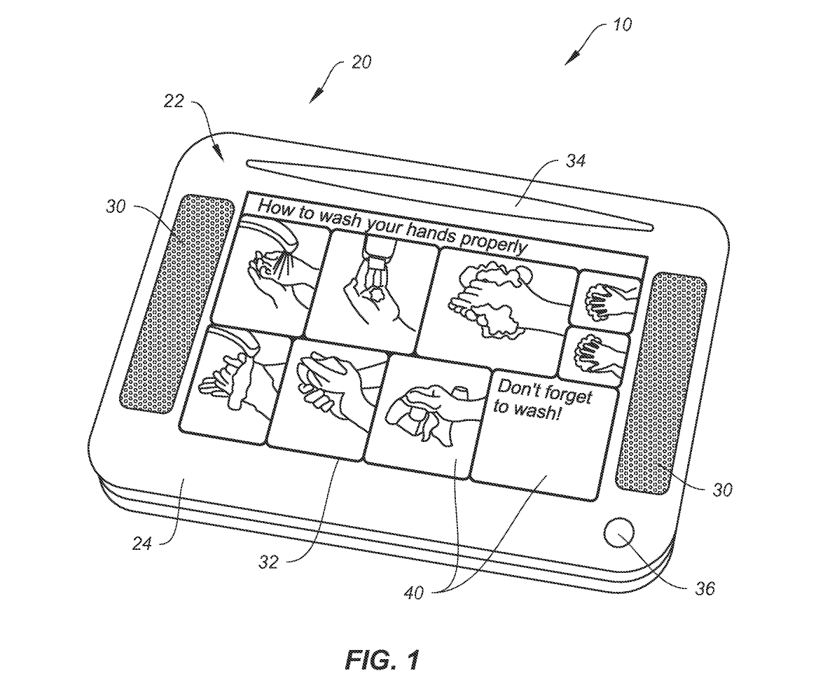

Turning now to the drawings, as illustrated in FIG. 1, in one embodiment the hand washing reminder 10 may comprise an electronic device 20 having a case 22, a front panel 24, and back panel 26. The case 22 may house internally contained audio speakers 30 for emitting the audio message. The electronic device 20 may also include a microphone 36 for recording the audio reminder or audio messages. In addition, the front panel 24 may be provided with a video display 32 that projects one or more visual cues 40 as a reminder to wash hands prior to leaving the restroom, or to provide instructions on proper hand washing techniques.

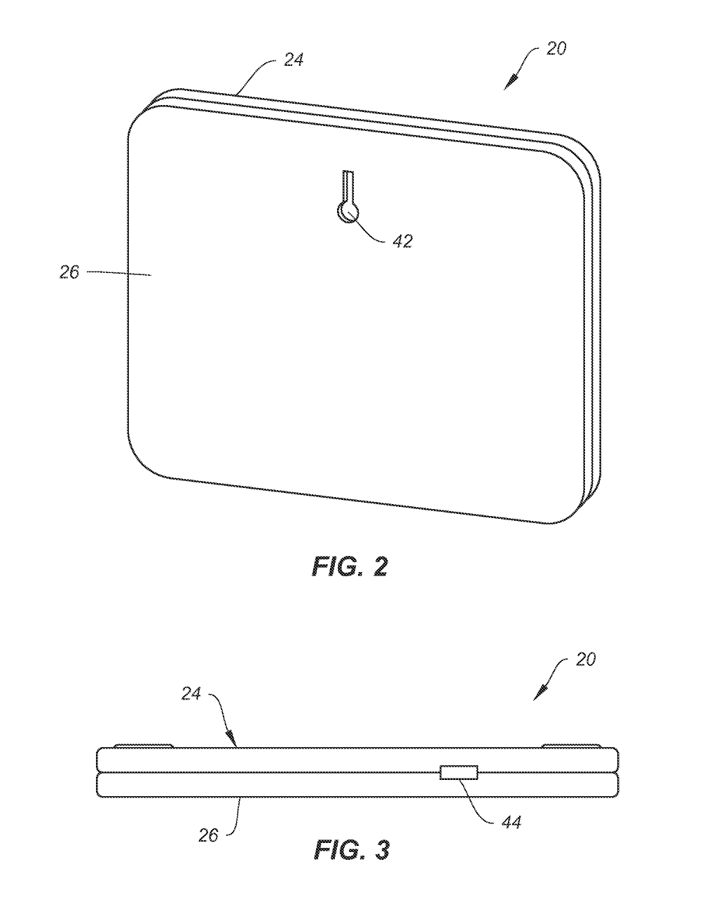

The electronic device 20 may also be configured as a motion detection device, and include a motion detector 34, such as for example, an infrared detector. The back panel 26 of the case 22 may include an opening 42, such as for example a keyhole mount opening, as illustrated in FIG. 2, to enable the electronic device 20 to be wall mounted. Of course, other types of fastening mechanisms may also be utilized, such as for example, with nails or adhesive. The device 20 may also be placed on a wall shelf or case, or mounted with a wall mount bracket similar to those used for video cameras, televisions or video displays.

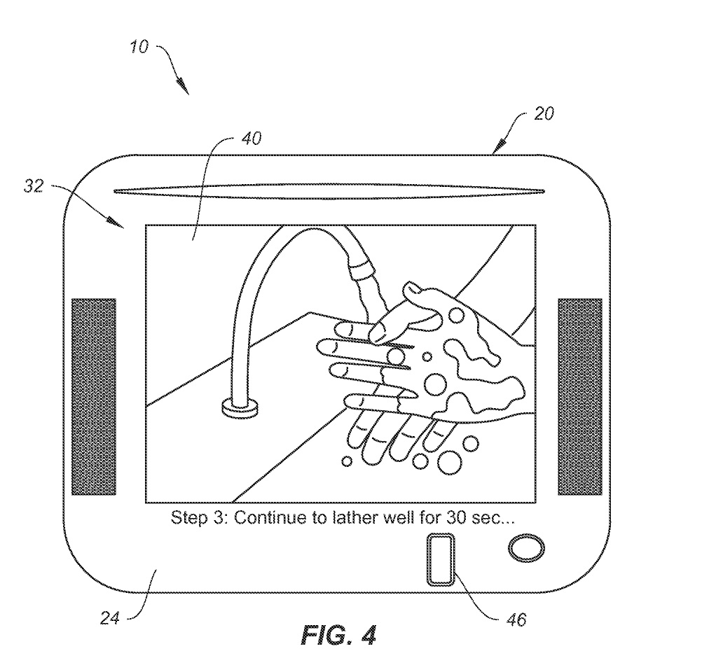

The electronic device 20 may be powered by a rechargeable battery such as a lithium battery, or may be powered using an AC/DC adapter. As shown in FIG. 3, the electronic device 20 may also be provided with a communications port, such as for example, a USB port 44 to download applications, video, and other electronic data to the device 20. The electronic device 20 may also be provided with wireless communication features such as internet compatibility, in order to receive messages quickly without the need for user download. In addition, in some embodiments, the electronic device 20 may be provided with additional features, such as a smoke alarm and/or a carbon monoxide detector 46, as shown in FIG. 4. The electronic device 20 may also be configured as a deodorizer or air freshener, and emit an odor-absorbing or odor-masking substance into the atmosphere.

As mentioned above, the reminder 10 may be provided with motion sensing features. Installed in a centralized spot, such as outside the stalls or between the sinks and the exit door of the restroom, in one embodiment the reminder 10 can be provided with an internally contained passive infrared detector 34, which could set up multiple zones of detection within a 360 degree field of view using a Fresnel® lens, for example. Motion is detected when people move from one zone to the next zone, automatically activating the audio device when a body breaks the infrared beam.

In its most basic form, the reminder 10 is configured to emit an audio message to patrons of restrooms reminding them to wash their hands. Accordingly, the electronic device 20 of the hand washing reminder 10 may contain one or more digital recordings that serve as the reminding system. The user of the device 20 may select from among a collection of more generalized statements prerecorded. Alternatively, the reminder 20 may permit users to record their own customized messages, via microphone 36, to urge restroom users to wash their hands. The device 20 is capable of playing and recording messages in virtually any language the user desires. In some cases, such as at an airport terminal restroom, the device 20 may be configured to provide the message in multiple languages. As conceived, when a restroom patron passes through the detection zone, the reminder 10 can issue a vocal request, such as, “Pardon me, please don't forget to wash your hands.” The sensor requires line of sight to detect motion; when the sensor detects no motion, it will not be activated. The activation can cause an internal timer to begin operating, issuing a reminder every five minutes.

In addition to, or as an alternative to, the audio message, the reminder 10 may also provide video displays to remind the patron to wash his or her hands, and/or to provide instructions on proper hand washing techniques. These video displays add a layer of interaction for the patron as well as the device provider. For example, when mounted in a clearly visible location such as near the sink area, the device 20 may provide a series of video cues that alert the patron to the display 32 on the front panel 24 of the device 20. The video cues 40 may be provided all at once, such as shown in FIG. 1, displaying the steps to properly wash hands. In one embodiment, the video clips may be illustrated figures or diagrams only. In another embodiment, the video cues may provide illustrations with text explaining the images. Alternatively, the video cues 40 may be displayed as a short video clip (for example, 10-20 seconds long), such that one clip representing one step of a series of steps may be displayed one after another, as shown in FIG. 4. In another embodiment, the video display may be a simple text message reading “Please remember to wash your hands.” This message may be provided as a scrolling message across the display 32, or as a static message.

It is contemplated that the video portion of the electronic device 20 may be used instead of, or in combination, with the audio portion. Accordingly, a single electronic device 20 may provide for both audio and video features (i.e., a standalone device). Where the electronic device 20 is configured to provide video displays only, the electronic device 20 may be used with external speakers to provide audio capabilities.

In another embodiment, two or more electronic devices may be electronically connected and used together as a system such that one of the two devices 20 may provide the audio portion, while the other of the two devices 20 may provide the video portion. The audio and video portions may be utilized simultaneously, or may be staged so that one portion starts before the other portion begins. Similar with the audio message, the video message may be provided in more than one language. Thus, the device 20 may be configured to provide the video message in multiple languages.

Another use for the video display is to provide advertising or warning messages to patrons. For example, where the hand washing reminder 10 is provided in a restaurant restroom, the restaurant owner may wish to have meal specials or other restaurant information displayed or emitted. If the reminder 10 is provided in an airport terminal, weather or flight information may also be provided. Amber alert information, emergency broadcasting information, and other similar types of warnings may be display and/or emitted as well. In addition, the health benefits of frequent hand washing can also be emitted. Reminders of work policies on hand washing, such as for restaurants and hospitals, may also be emitted. Such additional features would likely increase the attraction of business owners to utilize these hand washing reminders 10, as well as increase the likelihood that patrons would pay attention to the audio/video messages.

Although the hand washing reminder 10 is disclosed herein as being useful for public restrooms, it is understood that the hand washing reminder 10 may be used in many other situations with equal benefit and applicability. For example, the hand washing reminder 10 of the present invention may also be useful in a laboratory facility, where the laboratory personnel would benefit from a reminder to wash their hands and remove any toxic or harsh chemicals prior to leaving the laboratory. Similarly, the hand washing reminder 10 may be used in a cafeteria setting, whether in a school or hospital setting. Still another environment that can benefit from the features of this device 20 include a hospital, and in particular, the neonatal intensive care unit (NICU) and/or intensive care unit (ICU) portion of the hospital, where particular attention to cleanliness is needed, as patients here are more susceptible to infections. It is already well established that bacterial infections like methicillin-resistant Staphylococcus aureus (MRSA) is directly correlated to improper, or lack of, hand washing. Consequently, hospital staff that has direct contact with patients must practice proper hygiene to reduce the chances of spreading illnesses and diseases. Thus, it is contemplated that the hand washing reminder electronic message board has applicability and utility anywhere frequent hand washing is desired.

As discussed, the hand washing reminder 10 may be highly customized to the establishment, as well as to the target audience. The hand washing reminder 10 may provide the audio/video message in any number of languages, and may have context-specific references to the establishment where the reminder 10 is to reside. In a hospital setting, the audio/video messages may reference hospital staff and specific hospital policies, Federal and local regulatory guidelines (e.g., U.S. Occupational Safety and Health Administration (OSHA), Centers for Disease Control and Prevention (CDC), Food and Drug Administration (FDA), etc.), and bylaws. In a restaurant setting, the audio/video messages may reference guidelines, health code and employment rules regarding hand washing for employees who handle food. Where the target audience is young children, the audio/video messages may include kid-friendly and recognized characters such as cartoon characters or other small children, and a kid-friendly or child's voice to appeal to the younger audience.

There are several significant benefits and advantages associated with the hand washing reminder 10. Foremost, the reminder provides a simple and effective means of reminding those who use a public or business restroom that they should wash their hands before exiting. Utilizing motion detecting technology, the device 20 notices a user leaving the restroom, and questions the person as to whether they completed the hygienic ritual. Those who have washed their hands can simply leave the restroom, confident that they have completed this most necessary of tasks. Yet, people who may be in a hurry and simply did not consider washing their hands could be convinced by the reminder that they should turn around, and take the time to ensure that their hands are free of dirt and microbes. In this manner, the reminder 10 could effectively reduce the transfer of germs and bacteria that can result from improper hand washing or the complete lack thereof. Made available in all public or office restroom facilities, the reminder is particularly ideal for restaurants and health care establishments, reiterating how extremely important it is that these personnel must practice safe hygiene with every visit to the restroom. A universal product, the reminder proves beneficial in schools, as well as in the home.

The hand washing reminder of the present invention readily increases the awareness of the importance of hand washing. Installed in restrooms that are used by many people in the course of a day, the reminder proves an invaluable tool for everyone's health and well-being.

The foregoing exemplary descriptions and the illustrative preferred embodiments of the present invention have been explained in the drawings and described in detail, with varying modifications and alternative embodiments being taught. While the invention has been so shown, described and illustrated, it should be understood by those skilled in the art that equivalent changes in form and detail may be made therein without departing from the true spirit and scope of the invention, and that the scope of the present invention is to be limited only to the claims except as precluded by the prior art. Moreover, the invention as disclosed herein may be suitably practiced in the absence of the specific elements that are disclosed herein.

What is claimed is:

1. An electronic device for transmitting a message to wash hands, the device comprising:
a case comprising a front panel and back panel, the case housing an internal speaker and microphone for emitting and recording an audio message regarding hand washing, the device further including a motion detection sensor, wherein the activation of the motion detection sensor initiates the emission of the audio message.

2. The electronic device of claim 1, further including a video display on the front panel, the device being configured to transmit a video message regarding hand washing.

3. The electronic device of claim 2, wherein the video message comprises a series of diagrams illustrating proper hand washing techniques.

4. The electronic device of claim 2, wherein the video message comprises a video clip showing proper hand washing techniques.

5. The electronic device of claim 1, further including a communications port for attachment to another electronic device for downloading data.

6. The electronic device of claim 1, further including a smoke detector.

7. The electronic device of claim 1, further including a carbon monoxide detector.

8. The electronic device of claim 1, further being configured to release an odor-absorbing or odor-masking substance.

9. The electronic device of claim 1, further being wall mountable.

10. An electronic system for transmitting a message to wash hands, the system comprising:
at least one audio device comprising a case having a front panel and back panel, the case housing internal speakers and a microphone for emitting and recording an audio message regarding hand washing, and further including a motion detection sensor, wherein the activation of the motion detection sensor initiates the emission of the audio message; and
at least one video device in electronic communication with the at least one audio device, the at least one video device comprising a case having a front panel and back panel including a video display on the front panel and being configured to transmit a video message regarding hand washing.

11. The system of claim 10, wherein the video message comprises a series of diagrams illustrating proper hand washing techniques.

12. The system of claim 10, wherein the video message comprises a video clip showing proper hand washing techniques.

13. The system of claim 10, wherein the video device further includes a communications port for attachment to another electronic device for downloading data.

14. The system of claim 1, further including a smoke detector.

15. The system of claim 1, further including a carbon monoxide detector.

16. The system of claim 1, further being configured to release an odor-absorbing or odor-masking substance.

17. The system of claim 10, wherein the video message displays simultaneously with the audio message.

18. The system of claim 10, wherein the video message displays at a different time than the audio message.
